(19) United States
(12) Patent Application Publication
(10) Pub. No.: US 2007/0113251 A1
(43) Pub. Date: May 17, 2007

(54) DISPLAY CONTROL APPARATUS AND METHOD, RECORDING MEDIUM, AND PROGRAM THEREFOR

(75) Inventor: Shuichi Otsu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/550,549

(22) Filed: Oct. 18, 2006

(30) Foreign Application Priority Data
Oct. 25, 2005 (JP) 2005-309335

(51) Int. Cl. H04N 5/445; G06F 13/00; G06F 3/00; H04N 7/16

(52) U.S. Cl. 725/56; 725/39; 725/139

(57) ABSTRACT

A display control apparatus controlling display of a program guide includes a first calculator calculating a first display position at which a first index indicating the current time is displayed; a second calculator calculating, when the current time is included in a time slot where a designated program is broadcast, on the basis of the length of a designated program area and the broadcast duration of the designated program, a second display position at which a second index indicating how much of the designated program has been broadcast is displayed; and a display controller controlling the display to display the first index at the first display position to be superimposed on the program guide and, when the current time is included in the time slot in which the designated program is broadcast, to display the second index, instead of the first index, to be superimposed on the designated program area.

### CROSS REFERENCES TO RELATED APPLICATIONS

The present invention contains subject matter related to Japanese Patent Application JP 2005-309335 filed in the Japanese Patent Office on Oct. 25, 2005, the entire contents of which are incorporated herein by reference.

### BACKGROUND OF THE INVENTION

1. Field of the Invention

The present invention relates to display control apparatuses and methods, recording media, and programs therefor. More particularly, the present invention relates to a display control apparatus and method, a recording medium, and a program therefor for easily detecting how much of a currently-broadcast program has been broadcast.

2. Description of the Related Art

Proposals have been made for displaying a current time line indicating the current time so as to be superimposed on a program guide based on electronic program guide (EPG) data (for example, see Japanese Unexamined Patent Application Publication No. 2000-295558).

### SUMMARY OF THE INVENTION

A user may want to know how far a program currently being broadcast has progressed, that is, how much of the program has been broadcast.

In contrast, the size of a frame corresponding to each program (hereinafter referred to as a “program frame”) in a program guide depends on the amount of information for introducing the program (e.g., the title of the program, the names of actors, etc.) and does not necessarily depend on the actual broadcast duration. For example, in the case of a program of a short broadcast duration (e.g., five minutes), information about this program does not fit in its program frame whose size is proportional to the broadcast duration. Therefore, a large program frame whose size is larger than the size proportional to the broadcast duration is assigned to this program. That is, it is difficult to detect the accurate broadcast duration of each program from the size of the associated program frame.

Accordingly, as in the invention described in Japanese Unexamined Patent Application Publication No.

2000-295558, even when the current time line is displayed so as to be superimposed on the program guide, it is difficult to accurately detect how much of a currently-broadcast program has been broadcast since the size of each program frame does not accurately reflect the broadcast duration of each program. Even when the current time is displayed along with the program guide, it is necessary to calculate how much of a currently-broadcast program has been broadcast on the basis of the start time and the broadcast duration of the program and the current time.

Accordingly, it is desirable to easily detect how much of a currently-broadcast program has been broadcast.

According to an embodiment of the present invention, there is provided a display control apparatus for controlling display of a program guide including programs listed according to a time axis. The apparatus includes the following elements: first calculating means for calculating a first display position at which a first index is displayed to be superimposed on the program guide, the first index indicating the current time with reference to the time axis; second calculating means for calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and display control means for controlling the display of the program guide to display the first index at the first display position so as to be superimposed on the program guide and, when the current time is included in the time slot in which the designated program is broadcast, to display the second index, instead of the first index, to be superimposed on the designated program area.

The display control means may control the display of the program guide to move the first index and the second index at predetermined time intervals and, when the current time passes time slots of the displayed program guide, to change the time slots of the program guide to time slots including the current time.

The display control means may control the display of the program guide to change a display system in areas prior and subsequent to the current time indicated by the first index or the second index.

The display control means may control the display of the program guide so that the spacing between time-scale marks along the time axis is changeable in predetermined time units, and, in each time unit, the length in the time axis direction of an area where information about each program is displayed is substantially proportional to the broadcast duration of each program.

According to another embodiment of the present invention, there is provided a display control method, a program, or a recording medium having a program recorded thereon. The display control method is a method for controlling display of a program guide including programs listed according to a time axis. The program is a program allowing a computer to perform a display control process for controlling display of a program guide including programs listed according to a time axis. The display control method or process includes the steps of calculating a first display position at which a first index is displayed to be superimposed on the program guide, the first index indicating the current time with reference to the time axis; calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and controlling the display of the program guide to display the first index at the first display position so as to be superimposed on the program guide and, when the current time is included in the time slot in which the designated program is broadcast, to display the second index, instead of the first index, to be superimposed on the designated program area.

According to the embodiments of the present invention, a first display position at which a first index is displayed to be superimposed on a program guide is calculated. The first index indicates the current time with reference to a time axis. When the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area is calculated. The second index indicates how much of the designated program has been broadcast. The display of the program guide is controlled to display the first index at the first display position so as to be superimposed on the program guide and, when the current time is included in the time slot in which the designated program is broadcast, to display the second index, instead of the first index, to be superimposed on the designated program area.

As has been described above, according to the embodiments of the present invention, it is possible to easily detect the current time position in a program guide and to easily detect how much of a currently-broadcast program has been broadcast.

### BRIEF DESCRIPTION OF THE DRAWINGS

FIG. 1 is a block diagram showing a digital television (DTV) according to an embodiment of the present invention;

FIG. 2 is a diagram showing an example of a displayed program guide;

FIG. 3 is a diagram showing another example of the displayed program guide;

FIG. 4 is a block diagram showing an example of the functional structure realized by a controller shown in FIG. 1;

FIG. 5 is a flowchart of a process of displaying the program guide, which is performed by the DTV shown in FIG. 1;

FIG. 6 is a diagram showing another example of the displayed program guide;

FIG. 7 is a diagram showing another example of the displayed program guide;

FIG. 8 is a diagram showing another example of the displayed program guide;

FIG. 9 is a diagram showing another example of the displayed program guide; and

FIG. 10 is a block diagram showing an example of the structure of a personal computer.

### DESCRIPTION OF THE PREFERRED EMBODIMENTS

Before describing an embodiment of the present invention, the correspondence between the features of the claims and embodiments of the present invention disclosed in the specification or the drawings is discussed below. This description is intended to assure that an embodiment supporting the claimed invention is described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

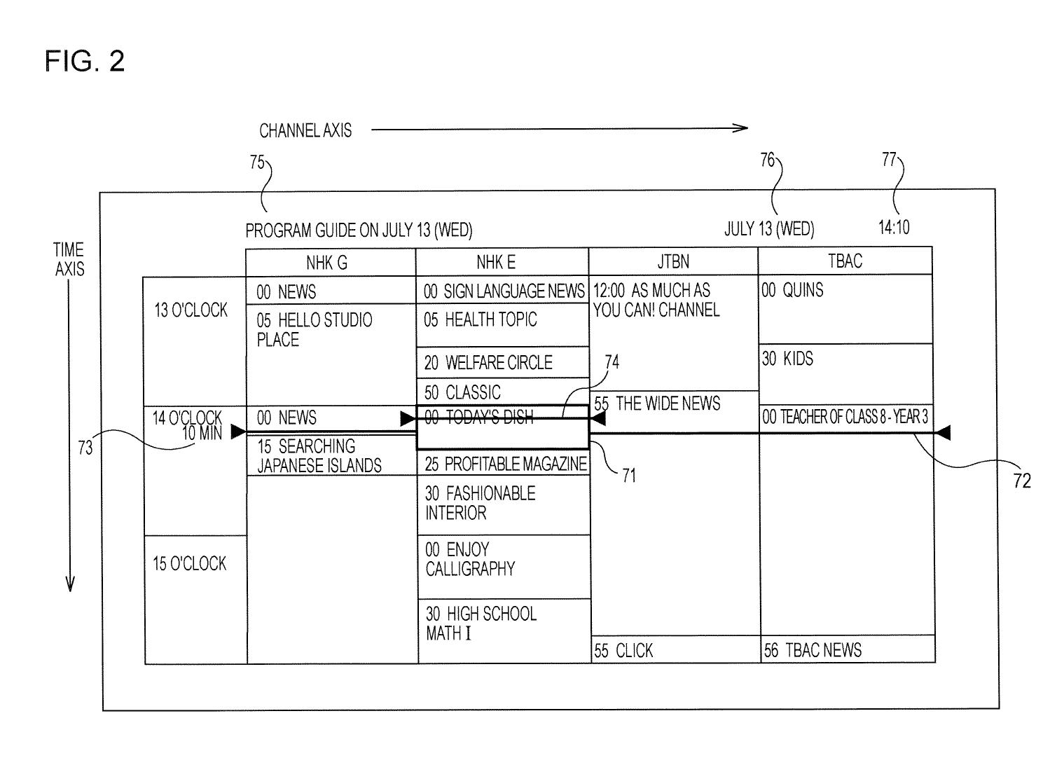

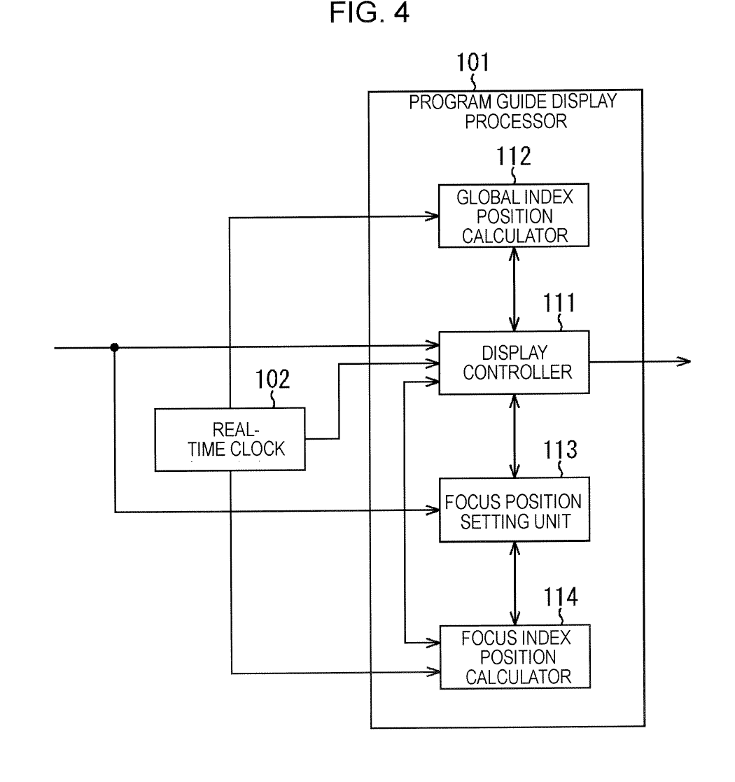

A display control apparatus according to an embodiment of the present invention is a display control apparatus (e.g., a program guide display processor 101 in FIG. 4) for controlling display of a program guide including programs listed according to a time axis. The apparatus includes the following elements: first calculating means (e.g., a global index position calculator 112 in FIG. 4) for calculating a first display position at which a first index (e.g., a global index 72 in FIG. 2) is displayed to be superimposed on the program guide, the first index indicating the current time with reference to the time axis; second calculating means (e.g., a focus index position calculator 114 in FIG. 2) for calculating, when the current time is included in a time slot in which a program designated from the program guide is broadcast, on the basis of the length in the time axis direction of a designated program area where information about the designated program is displayed and the broadcast duration of the designated program, a second display position at which a second index (e.g., a focus index 74 in FIG. 2) is displayed to be superimposed on the designated program area, the second index indicating how much of the designated program has been broadcast; and display control means (e.g., a display controller 111 in FIG. 4) for controlling the display of the program guide to display the first index at the first display position so as to be superimposed on the program guide and, when the current time is included in the time slot in which the designated program is broadcast, to display the second index, instead of the first index, to be superimposed on the designated program area.

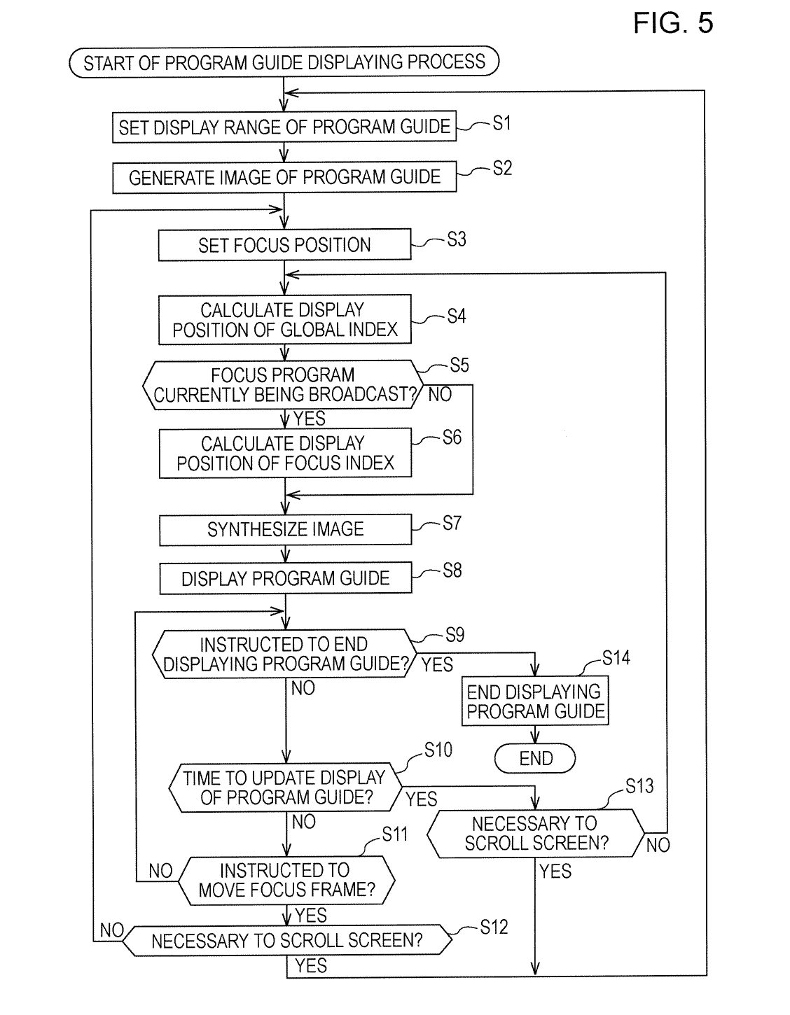

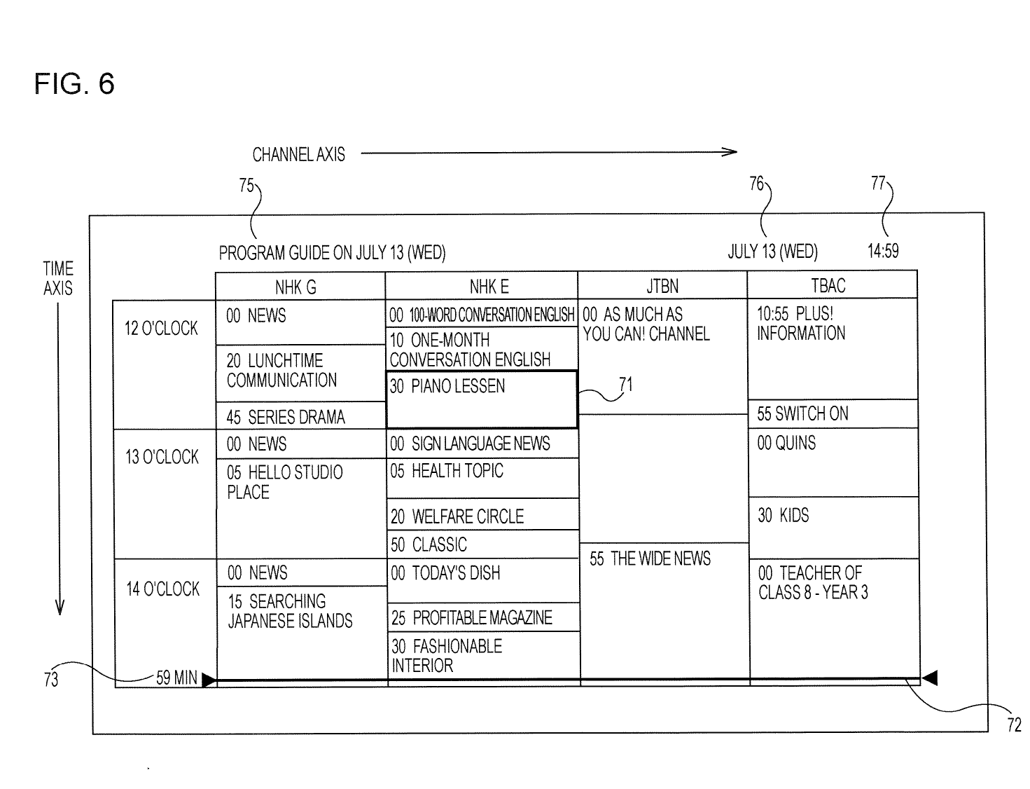

A display control method, a program, or a recording medium having a program recorded thereon according to an embodiment of the present invention is a display control method for controlling display of a program guide including programs listed according to a time axis or a program allowing a computer to perform a display control process for controlling display of a program guide including programs listed according to a time axis. The display control method or process includes the steps of calculating a first display position at which a first index is displayed to be superimposed on the program guide, the first index indicating the current time with reference to the time axis (e.g., step S4 in FIG. 5); calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast (e.g., step S6 in FIG. 5); and controlling the display of the program guide to display the first index at the first display position so as to be superimposed on the program guide and, when the current time is included in the time slot in which the designated program is broadcast, to display the second index, instead of the first index, to be superimposed on the designated program area (e.g., step S8 in FIG. 6).

An embodiment of the present invention will now be described with reference to the accompanying drawings.

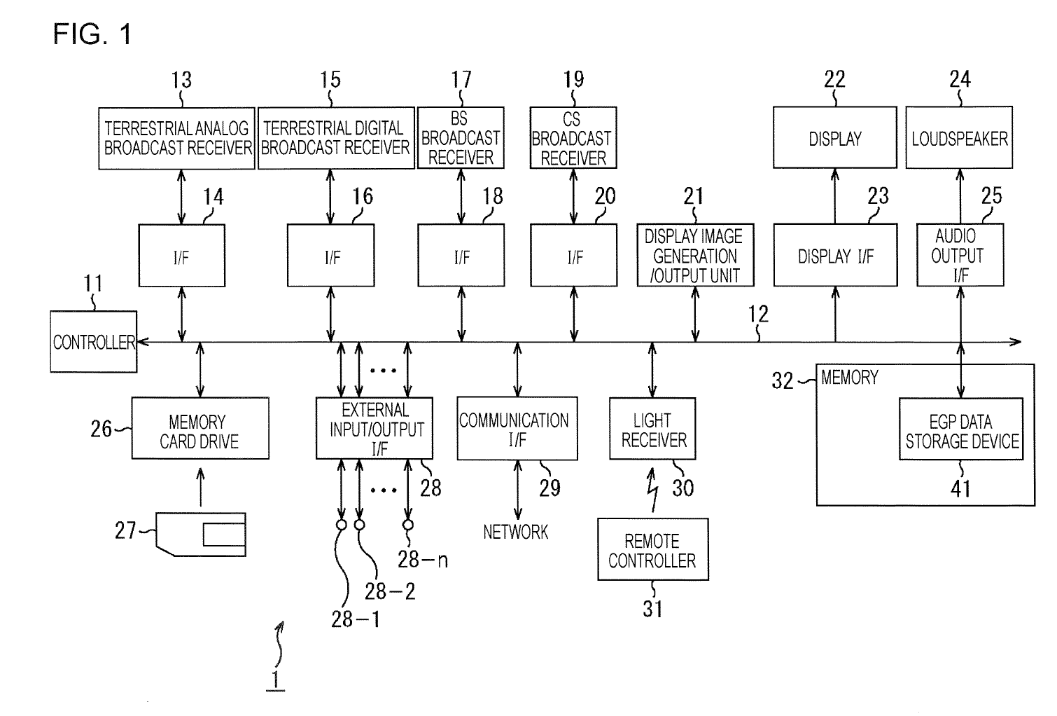

FIG. 1 is a block diagram showing an example of the structure of a digital television (DTV) according to an embodiment of the present invention.

The DTV 1 includes a controller 11, a bus 12, a terrestrial analog broadcast receiver 13, an interface 14, a terrestrial digital broadcast receiver 15, an interface 16, a broadcasting satellite (BS) broadcast receiver 17, an interface 18, a communications satellite (CS) broadcast receiver 19, an interface 20, a display image generation/output unit 21, a display 22, a display interface 23, a loudspeaker 24, an audio output interface 25, a memory card drive 26, an external input/output interface 28, a communication interface 29, a light receiver 30, a remote controller 31, and a memory 32. The DTV 1 includes these processors, which are connected via the bus 12 to the controller 11 including a central processing unit (CPU), a read only memory (ROM), a random access memory (RAM), or the like.

Under the control of the controller 11, the terrestrial analog broadcast receiver 13 receives a terrestrial analog television broadcast signal, demodulates the received signal to obtain an image signal (video signal) and an audio signal, and outputs the image signal (video signal) and the audio signal to the bus 12 via the interface 14. The controller 11 gives an instruction to the terrestrial analog broadcast receiver 13 to receive a channel selected by a user by operating the remote controller 31. To the other broadcast receivers, the controller 11 similarly gives instructions in response to user operations.

The terrestrial digital broadcast receiver 15 corresponds to digital television broadcasting and data broadcasting. Under the control of the controller 11, the terrestrial digital broadcast receiver 15 receives a terrestrial digital broadcast signal. The terrestrial digital broadcast receiver 15 decodes the broadcast signal to obtain a program's image signal and audio signal, EPG data, and the like and outputs the obtained signals and data to the bus 12 via the interface 16.

The BS broadcast receiver 17 corresponds to BS television broadcasting, BS audio broadcasting (radio broadcasting), and data broadcasting. Under the control of the controller 11, the BS broadcast receiver 17 receives a BS digital broadcast signal. The BS broadcast receiver 17 decodes the broadcast signal to obtain a program's image signal and audio signal, EPG data, and the like and outputs the obtained signals and data to the bus 12 via the interface 18.

The CS broadcast receiver 19 corresponds to CS television broadcasting, CS audio broadcasting, and data broadcasting. Under the control of the controller 11, the CS broadcast receiver 19 receives a CS digital broadcast signal. The CS broadcast receiver 19 decodes the broadcast signal to obtain a program's image signal and audio signal, EPG data, and the like and outputs the obtained signals and data to the bus 12 via the interface 20.

Under the control of the controller 11, the display image generation/output unit 21 displays various images on the display 22. For example, the display image generation/output unit 21 displays a program's image on the display 22 on the basis of the image data supplied via the bus 12 from each of the terrestrial analog broadcast receiver 13, the terrestrial digital broadcast receiver 15, the BS broadcast receiver 17, and the CS broadcast receiver 19. At the time the program's image is displayed by the display image generation/output unit 21, the program's sounds are output from the loudspeaker 24 under the control of the controller 11.

Under the controller 11, the display image generation/output unit 21 displays a program guide including various broadcast programs (hereinafter may also be referred to as an “EPG display screen”) on the basis of the EGP data stored in an EGP data storage device 41 of the memory 32.

When the display image generation/output unit 21 is informed by the controller 11 of a user operation on the EPG display screen, the display image generation/output unit 21 changes the EPG display screen in response to the user operation.

The display 22 includes a liquid crystal display (LCD) or the like. Under the control of the display image generation/output unit 21 via the bus 12 and the display interface 23, the display 22 displays a program's image, the EGP display screen, or the like. The EGP display screen displayed on the display 22 will be described subsequently.

Under the control of the controller 11, the loudspeaker 24 outputs sounds associated with audio data supplied from each of the terrestrial analog broadcast receiver 13, the terrestrial digital broadcast receiver 15, the BS broadcast receiver 17, and the CS broadcast receiver 19 via the bus 12 and the audio output interface 25.

The memory card drive 26 reads data from a memory card 27 installed in a slot in a housing of the DTV 1 and writes data to the memory card 27. For example, still image data captured with a digital camera or the like is read from the memory card 27 and output via the bus 12 to the display image generation/output unit 21. The display image generation/output unit 21 displays a still image on the basis of the data read from the memory card 27.

The external input/output interface 28 performs transmission and reception of data (signals) to and from devices connected via various cables to external input/output terminals 28-1 to 28-n including video input/output terminals, audio input/output terminals, a Universal Serial Bus (USB) terminal, an Institute of Electrical and Electronics Engineers (IEEE) 1394 terminal, and a High-Definition Multimedia Interface (HDMI) terminal provided on the housing of the DTV 1.

For example, when a digital camera or an audio player is connected to the DTV 1 via a USB cable, the external input/output interface 28 obtains still image data captured with the digital camera or audio data stored in the audio player. When a hard disk recorder (HDR) is connected to the DTV 1 via an IEEE 1394 cable, the external input/output interface 28 outputs digital broadcasting program data (image signal and audio signal) obtained by the terrestrial digital broadcast receiver 15 via the IEEE 1394 cable to the HDR, which in turn stores the program data. Also, the external input/output interface 28 obtains the program data stored in the HDR via the IEEE 1394 cable and outputs the obtained data to the display image generation/output unit 21, which in turn displays the program's image.

The communication interface 29 performs data transmission and reception with various devices via a network. For example, when a network-compatible recorder/player is connected via the network to the DTV 1, the communication interface 29 transmits digital broadcast program data obtained by the terrestrial digital broadcast receiver 15 to the recorder/player, which in turn stores the program data. Also, the communication interface 29 outputs the program data supplied via the network from the recorder/player to the display image generation/output unit 21, which in turn displays the program's image.

The light receiver 30 receives infrared light emitted from the remote controller 31, demodulates the light to obtain a signal associated with the user operation, and outputs the signal to the controller 11 via the bus 12. The remote controller 31 includes, besides a cross key and a determination key, for example, a home key operated to display a menu screen.

The memory 32 includes a flash memory or the like. The EGP data storage device 41 is provided in the memory 32.

The EGP data storage device 41 stores the EPG data obtained from the terrestrial analog broadcast receiver 13, the terrestrial digital broadcast receiver 15, the BS broadcast receiver 17, and the CS broadcast receiver 19. The EPG data includes information about each program's broadcasting station name (channel name), title, broadcast start time, broadcast end time, actors, genre, or the like and is used to display a program guide. Alternatively, EPG data downloaded from a predetermined server by the communication interface 29 may be stored in the EGP data storage device 41 and used to display a program guide.

A program guide displayed by the DTV 1 with the above-described structure will be described.

FIG. 2 is a diagram showing an example of a program guide displayed on the display 22.

The program guide shown in FIG. 2 is displayed in response to, for example, a user operating the remote controller 31. Using the program guide, the user can, for example, check the schedule or the contents of each program to be broadcast, select a program to be displayed on the display 22, or set timer recording.

The program guide is a two-dimensional table with a channel axis in the horizontal direction and a time axis in the vertical direction. The names of broadcasting stations are displayed in the order of channels in the top row of the program guide in the channel axis direction (hereinafter referred to as a “broadcasting station display row”). For example, in FIG. 2, the names of four broadcasting stations, namely, Nippon Hoso Kyokai (NHK) General (NHK G), NHK Education (NHK E), JTBN, and TBAC, are displayed. Time-scale marks indicating time slots of the displayed program guide are displayed in the left column of the program guide in the time axis direction (hereinafter referred to as a “time-slot display column”). For example, in FIG. 2, time-scale marks are displayed indicating that a program guide from the order of 13 o'clock to the order of 15 o'clock is displayed.

In columns of the program guide, which are associated with the broadcasting stations, program frames serving as areas where information about programs to be broadcast by the associated broadcasting stations are displayed side by side in chronological order along the time axis. In each program frame, for example, information about each program's start time, title, actors, or the like is displayed.

A focus frame 71 for designating a program in the program guide is displayed so as to surround one program in the program guide. For example, the user operates the remote controller 31 to move the focus frame 71 vertically and horizontally to change the program to be designated. For example, the user moves the focus frame 71 to scroll the program guide in predetermined time units (for example, one hour) or in units of a predetermined number of broadcasting stations (for example, one station). For example, the user operates the remote controller 31 to scroll the program guide in units of pages or to change the date of a program guide to be displayed.

In the following description, a program designated by the focus frame 71 is referred to as a focus program, and the position of a program frame where the focus frame 71 is displayed is referred to as a focus position.

A global index 72 serving as an index for indicating the current time with reference to the time axis of the program guide is displayed so as to be superimposed on the program guide. The global index 72 is displayed at a position indicating the current time with reference to the time-scale marks displayed in the time-slot display column, as a straight line parallel to the channel axis and perpendicular to the time axis. For example, if the current time is 14:10, the global index 72 is displayed at a position lower from the time-scale mark indicating 14 o'clock by one sixth of the spacing between the time-scale mark indicating 14 o'clock and the time-scale mark indicating 15 o'clock (=10 minutes/60 minutes), as a straight line parallel to the channel axis and perpendicular to the time axis. A character string 73 indicating the time (minutes) indicated by the global index 72 is displayed in the vicinity of the global index 72 in the time-slot display column.

When the focus program is currently being broadcast, that is, when the current time is included in the time slot in which the focus program is broadcast, a focus index 74 indicating how much of the focus program has been broadcast is displayed, instead of the global index 72, in a program frame associated with the focus program (hereinafter referred to as a“focus program frame”). The focus index 74 is displayed at a position indicating the current time with reference to the time-scale marks obtained by dividing the length (height) of the focus program frame in the time axis direction by the broadcast duration of the focus program, as a straight line parallel to the channel axis and perpendicular to the time axis.

For example, when the focus program is “Today's Dish”, which is broadcast at 14:00 for 25 minutes, and when the current time is 14:10, the focus index 74 is displayed at a position indicating the current time with reference to the time-scale marks obtained by dividing the height of the program frame of“Today's Dish” into 25 equal portions (that is, at the position of the 10-th time-scale mark from the top end of the program frame (though the top end of the program frame is not counted as a time-scale mark)). Thus, the focus index 74 is displayed at a position that substantially accurately indicates how much of the focus program has been currently broadcast in the focus program guide, regardless of the length of the focus program frame in the time-axis direction or the broadcast duration of the focus program.

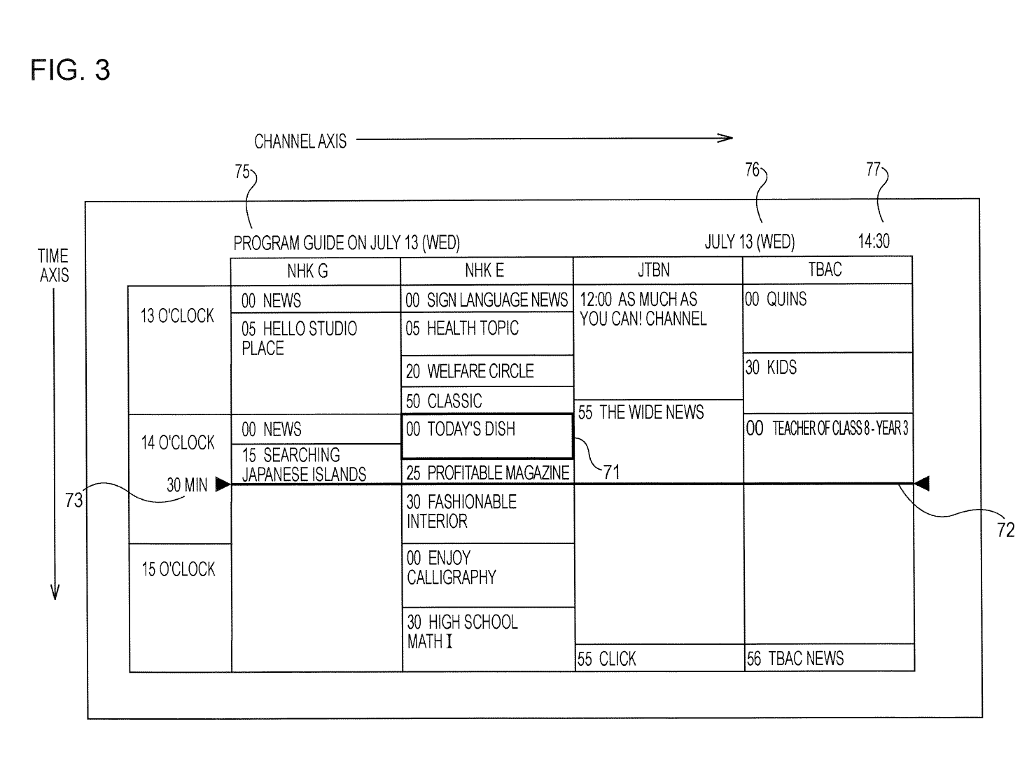

Since the global index 72 is not displayed in the column where the focus index 74 is displayed, the global index 72 may be displayed as two separate straight lines. When the focus program is not currently being broadcast, that is, when the current time is not included in the time slot in which the focus program is broadcast, as shown in FIG. 3, the focus index 74 is not displayed, and only the global index 72 is displayed so as to be superimposed on the program guide.

A character string 75 indicating the date and the day of the program guide being displayed is displayed in the upper left-hand corner of the program guide. A character string 76 indicating the current date and the current day and a character string 77 indicating the current time are displayed in the upper right-hand corner of the program guide.

FIG. 4 is a block diagram showing an example of the functional structure of a program guide display processor 101 realized by executing a predetermined program by the controller 11 shown in FIG. 1. By executing the program by the controller 11, the program guide display processor 101 including a display controller 111, a global index position calculator 112, a focus position setting unit 113, and a focus index position calculator 114 is realized.

The display controller 111 obtains the EPG data from the EGP data storage device 41 via the bus 12. The display controller 111 obtains information indicating various instructions input by the user using the remote controller 31 from the light receiver 30 via the bus 12. The display controller 111 obtains information indicating the current time from a real-time clock 102.

On the basis of a user instruction or the like, the display controller 111 sets a display range (the number of time slots and the number of broadcasting stations) of a program guide to be displayed on the display 22. On the basis of the EPG data, the display controller 111 calculates the display positions of program frames associated with programs in the program guide. The display controller 111 supplies program guide display information including the display range of the program guide, the positions of the time-scale marks indicating the time slots of the program guide, which are displayed in the time-slot display column, the positions of columns associated with the broadcasting stations, the display positions of the program frames, and the details of the character strings 75 to 77 to the global index position calculator 112, the focus position setting unit 113, and the focus index position calculator 114. Also, the display controller 111 supplies the program guide display information to the display image generation/output unit 21 via the bus 12.

The display controller 111 obtains global index position information indicating the display position of the global index 72 from the global index position calculator 112 and supplies the obtained global index position information to the display image generation/output unit 21 via the bus 12. The display controller ill obtains focus position information indicating the focus position from the focus position setting unit 113 and supplies the obtained focus position information to the display image generation/output unit 21 via the bus 12. The display controller 111 obtains focus index position information indicating the display position of the focus index 74 from the focus index position calculator 114 and supplies the obtained focus index position information to the display image generation/output unit 21 via the bus 12. The display controller 111 supplies the information indicating the current time to the display image generation/output unit 21 via the bus 12.

The global index position calculator 112 obtains the information indicating the current time from the real-time clock 102. The global index position calculator 112 calculates the display position of the global index 72, as will be described subsequently with reference to FIG. 5. The global index position calculator 112 supplies the global index position information indicating the calculated display position of the global index 72 to the display controller 111.

The focus position setting unit 113 obtains information indicating an instruction to move the focus frame 71, which is input from the user using the remote controller 31, from the light receiver 30 via the bus 12. On the basis of a user instruction or the like, the focus position setting unit 113 selects a program frame where the focus frame 71 is to be displayed. The focus position setting unit 113 supplies the position of the program frame where the focus frame 71 is to be displayed, that is, the focus position information indicating the focus position, to the display controller 111 and the focus index position calculator 114.

The focus index position calculator 114 obtains the information indicating the current time from the real-time clock 102. As will be described subsequently with reference to FIG. 5, the focus index position calculator 114 calculates the display position of the focus index 74. The focus index position calculator 114 supplies the focus index position information indicating the calculated display position of the focus index 74 to the display controller 111.

Next, with reference to the flowchart of FIG. 5, a program guide displaying process performed by the DTV 1 will be described. This process starts when, for example, the user uses the remote controller 31 to display a program guide on the display 22 and information instructing the display 22 to start displaying the program guide is supplied from the light receiver 30 via the bus 12 to the display controller 111.

In step S1, the display controller 111 sets a display range of the program guide. Specifically, the display controller 111 obtains the EPG data from the EGP data storage device 41 via the bus 12. The display controller 111 also obtains the information indicating the current time from the real-time clock 102. The display controller 111 sets, as the display range of the program guide, a range including time slots and broadcasting stations designated by the user. On the basis of the EPG data, the display controller 111 calculates the display positions of program frames associated with programs in the program guide. The display controller 111 supplies program guide display information including the display range of the program guide, the positions of the time-scale marks indicating the time slots of the program guide, which are displayed in the time-slot display column, the positions of columns associated with the broadcasting stations, the display positions of the program frames, and the details of the character strings 75 to 77 to the global index position calculator 112, the focus position setting unit 113, and the focus index position calculator 114.

In step S2, the display image generation/output unit 21 generates an image of the program guide. Specifically, the display controller 111 supplies the program guide display information to the display image generation/output unit 21 via the bus 12. The display image generation/output unit 21 obtains the EGP data from the EGP data storage device 41 via the bus 12. On the basis of the program guide display information and the EPG data, the display image generation/output unit 21 generates an image of the program guide to be displayed on the display 22.

In step S3, the focus position setting unit 113 sets the focus position. Specifically, the focus position setting unit 113 selects, in accordance with a predetermined rule, the program frame where the focus frame 71 is to be displayed at the time the displaying of the program guide starts. The focus position setting unit 113 supplies the focus position information indicating the focus position to the display controller 111 and the focus index position calculator 114.

In step S4, the global index position calculator 112 calculates the display position of the global index 72. Specifically, the global index position calculator 112 obtains the information indicating the current time from the real-time clock 102. The global index position calculator 112 calculates the position of the current time with reference to the time-scale marks indicating the time slots of the program guide, which are displayed in the time-slot display column displayed on the basis of the program guide display information. That is, the global index position calculator 112 calculates the display position of the global index 72. The global index position calculator 112 supplies the global index position information indicating the calculated display position of the global index 72 to the display controller 111.

In step S5, the focus index position calculator 114 determines whether the focus program is currently being broadcast. Specifically, the focus index position calculator 114 obtains the information indicating the current time from the real-time clock 102. On the basis of the program guide display information and the focus position information, the focus index position calculator 114 obtains the broadcast time slot of the program (focus program) designated by the focus frame 71. When the time slot in which the focus program is broadcast includes the current time, the focus index position calculator 114 determines that the focus program is currently being broadcast, and the flow proceeds to step S6.

In step S6, the focus index position calculator 114 calculates the display position of the focus index 74. Specifically, on the basis of the program guide display information and the focus position information, the focus index position calculator 114 obtains the length (height) of the focus program frame in the time-axis direction. The focus index position calculator 114 calculates the position indicating the current time with reference to the time-scale marks obtained by dividing the length (height) of the focus program frame in the time-axis direction by the broadcast duration (the number of minutes) of the focus program. That is, the focus index position calculator 114 calculates the display position of the focus index 74. The focus index position calculator 114 supplies the focus index position information indicating the calculated display position of the focus index 74 to the display controller 111.

If it is determined in step S5 that the focus program is not currently being broadcast, the processing in step S6 is skipped, and the flow proceeds to step S7.

In step S7, the display image generation/output unit 21 synthesizes an image. Specifically, the display controller 111 supplies the global index position information, the focus position information, and the information indicating the current time to the display image generation/output unit 21 via the bus 12. In the program guide image generated in step S2, the display image generation/output unit 21 superimposes the focus frame 71 on the program frame indicated by the focus position information, and superimposes the global index 72 at the position indicated by the global index position information. The display image generation/output unit 21 superimposes the character string 73 indicating the current time (minutes) in the vicinity of the global index 72 in the time-slot display column.

When the focus program is currently being broadcast, the display controller 111 supplies the focus index position information to the display image generation/output unit 21 via the bus 12. The display image generation/output unit 21 superimposes the focus index 74, instead of the global index 72, at the position indicated by the focus position information in the focus program frame. The display image generation/output unit 21 deletes the straight line of the global index 72 from the column where the focus frame 71 is displayed.

In step S8, the display image generation/output unit 21 displays the program guide. Specifically, the display image generation/output unit 21 supplies the image synthesized in step S7 to the display 22 via the bus 12 and the display interface 23. The supplied image, that is, the program guide such as that described as above with reference to FIG. 2 or 3, is displayed on the display 22.

In step S9, the controller 11 determines whether an instruction is given to end displaying the program guide. If no instruction is given to end displaying the program guide, the flow proceeds to step S10.

In step S10, the display controller 111 determines whether it is time to update the display of the program guide. The display controller 111 obtains the information indicating the current time from the real-time clock 102. If the display controller 111 determines that the current time is not the time to update the display of the program guide, the flow proceeds to step S11.

In step S11, the display controller 111 determines whether an instruction is given to move the focus frame 71. If no instruction is given to move the focus frame 71, the flow returns to step S9.

Thereafter, the processing from step S9 to step S11 is repeated until it is determined in step S9 that an instruction is given to end displaying the program guide or it is determined in step S10 that it is time to update the display of the program guide.

For example, when the user uses the remote controller 31 to move the focus frame 71, and information instructing the movement of the focus frame 71 is supplied from the light receiver 30 via the bus 12 to the display controller 111 and the focus position setting unit 113, in step S11, the display controller 111 determines that it is instructed to move the focus frame 71, and the flow proceeds to step S12.

In step S12, the display controller 111 determines whether it is necessary to scroll the screen. When the movement of the focus frame 71 is out of the range of the currently displayed program guide, the display controller 111 determines that it is necessary to scroll the screen, and the flow returns to step S1.

Thereafter, in step S1, a display range of the program guide is set by scrolling the program guide by a predetermined amount in the direction of movement of the focus frame 71, and the program guide within the set display range is displayed on the display 22. That is, the program guide is scrolled in the direction of movement of the focus frame 71.

If it is determined in step S12 that it is unnecessary to scroll the screen, that is, if the movement of the focus frame 71 is within the range of the currently displayed program guide, the flow returns to step S3.

Thereafter, in step S3, a new focus position is set, and the program guide where the focus frame 71 is moved to the set position is displayed on the display 22.

If it is determined in step S10 that it is time to update the display of the program guide, the flow proceeds to step S13. For example, the display of the program guide is updated at intervals of predetermined minutes (e.g., every ten minutes or every five minutes).

In step S13, the display controller 111 determines whether it is necessary to scroll the screen. If the current time is not included in the time slots of the currently displayed program guide, the display controller 111 determines that it is necessary to scroll the screen, and the flow returns to step S1.

Thereafter, in step S1, a display range of the program guide is set by scrolling the program guide by a predetermined time so that the current time is included in the program guide, and the program guide within the set display range is displayed on the display 22. That is, as the time progresses, the program guide is automatically scrolled in predetermined time units.

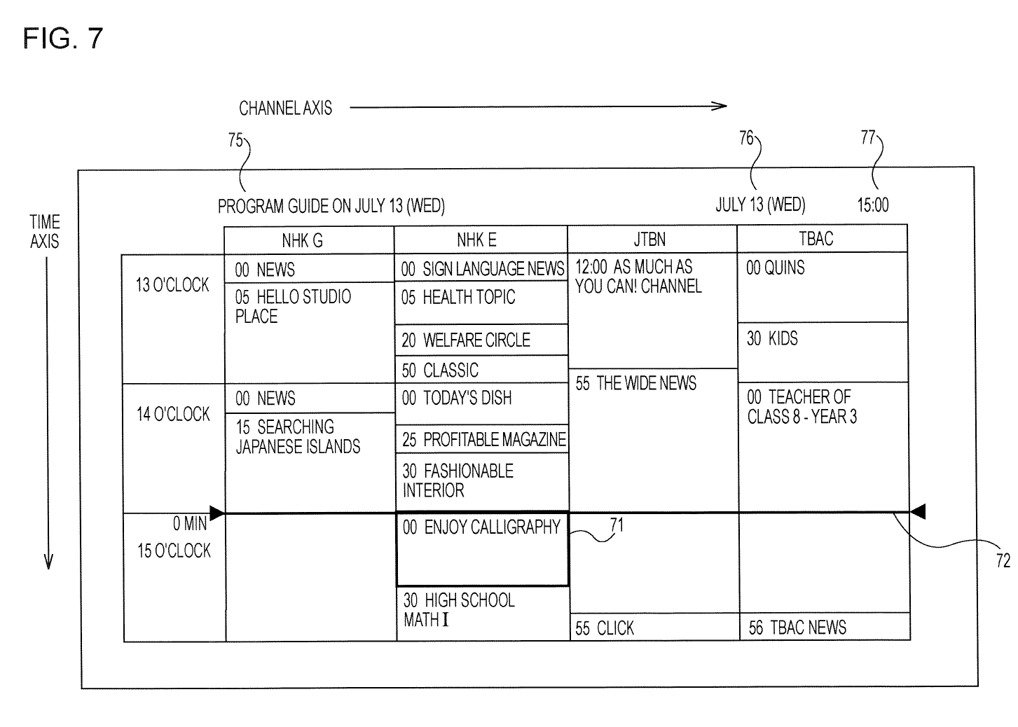

For example, in the case where the display of the program guide is updated every minute, when one minute passes from 14:59 at which a screen shown in FIG. 6 is displayed on the display 22 and the time becomes 15:00, as shown in FIG. 7, the display of the program guide is scrolled so that the time slots of the program guide displayed on the display 2 are moved one hour forward.

When the time slot in which the focus frame 71 is displayed disappears as the program guide is scrolled, the focus frame 71 is moved according to a predetermined rule. FIGS. 6 and 7 show an example where, as the program guide is scrolled, the focus frame 71 displayed in the program frame of “Piano Lesson”, which is broadcast on the NHK E channel from 12:30, is moved to the program frame of “Enjoy Calligraphy”, which is currently being broadcast on the same NHK E channel.

If it is determined in step S13 that it is unnecessary to scroll the screen, that is, if the current time is included in the time slots of the currently displayed program guide, the flow returns to step S4.

Thereafter, the processing from step S4 onward is performed. As the time progresses, the program guide where the global index 72 and the focus index 74 are moved accordingly is displayed on the display 22.

For example, when the user uses the remote controller 31 to give an instruction to end displaying the program guide, and information indicating the instruction to end displaying the program guide is supplied from the light receiver 30 via the bus 12 to the display controller 111, the display controller 111 determines in step S9 that it is instructed to end displaying the program guide, and the flow proceeds to step S14.

In step S14, the display controller 111 controls the display image generation/output unit 21 to end displaying the program guide, and the program guide displaying process ends.

In this manner, since the global index 72 and the focus index 74 are displayed, the user can easily know the position of the current time in the program guide and how much of the currently-broadcast focus program has been broadcast. Since the display of the program guide is automatically scrolled as the time progresses, the user-friendliness is enhanced.

Another example of the displayed program guide for enabling the user to know how much of a currently-broadcast program has been broadcast in an easier manner will be described.

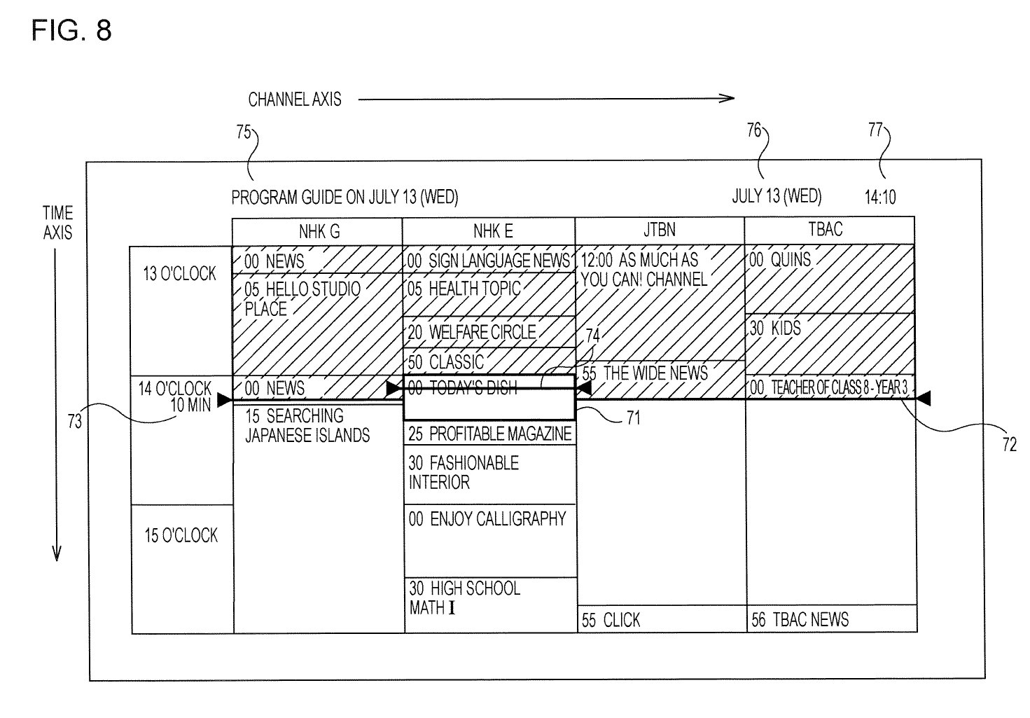

For example, as shown in FIG. 8, different display systems may be used to display an area prior to the current time indicated by the global index 72 and the focus index 74 (a shadowed area, which is referred to as an “already-broadcast area”) and to display an area subsequent to the current time (hereinafter referred to as a “to-be-broadcast area”). For example, different background colors or different patterns may be used in the already-broadcast area and the to-be-broadcast area, or characters of different colors or different fonts may be used in the already-broadcast area and the to-be-broadcast area. Accordingly, the user can promptly distinguish the already-broadcast portion from the portion to be broadcast. Also, the user can promptly and easily find the positions of the global index 72 and the focus index 74, thereby promptly and easily knowing how much of the currently-broadcast program has been broadcast.

In order to display the program guide shown in FIG. 8, for example, the display controller 111 supplies information instructing the display systems for displaying the already-broadcast area and the to-be-broadcast area to the display image generation/output unit 21.

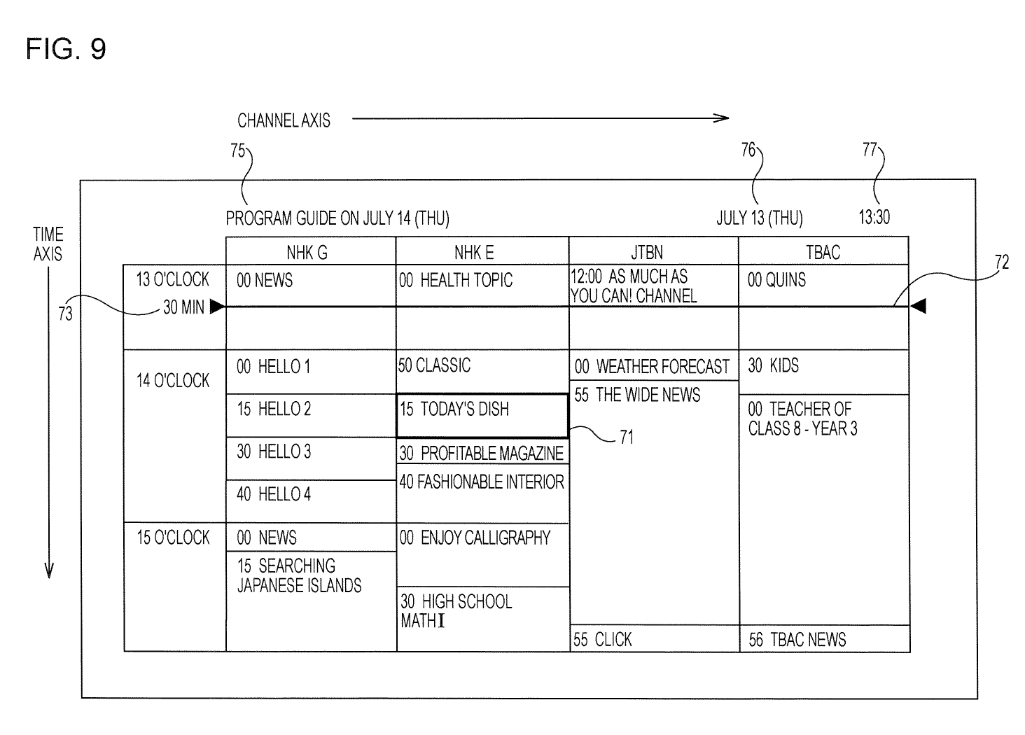

For example, as shown in FIG. 9, the spacing between the time-scale marks indicating the time slots of the program guide, which are displayed in the time-slot display column, may be changeable in predetermined time units (one hour in the example shown in FIG. 9). In each time unit, the length of each program frame in the time-axis direction may be set to be substantially proportional to the broadcast duration of each program.

For example, in the example shown in FIG. 9, the broadcasting stations each broadcast only one program from 13 o'clock to 14 o'clock (the order of 13 o'clock). Therefore, the spacing between the time-scale marks indicating 13 o'clock and 14 o'clock is set to be narrow. In contrast, from 14 o'clock to 15 o'clock (on the order of 14 o'clock), two channels, namely, the NHK G channel and the NHK E channel, each broadcast four programs. Therefore, the spacing between the time-scale marks indicating 14 o'clock and 15 o'clock is set to be wider than that between the time-scale marks indicating 13′ o'clock and 14 o'clock so that information about each program can be displayed in each associated program frame and that the height of each program frame is substantially proportional to the broadcast duration of each program. Accordingly, the user can easily know the ratio among the programs broadcast in the same time unit. Without using the focus index 74, the current time and how much of the currently-broadcast program has been broadcast can be indicated only using the global index 72. Therefore, the user can easily know the relationship between the current time and how much of the currently-broadcast program has been broadcast.

To display the program guide shown in FIG. 9, for example, on the basis of the EPG data, the display controller 111 sets the spacing between the time-scale marks indicating the time slots of the program frame in accordance with the number of programs to be broadcast on the order of the same time (hour), the broadcast duration of each program, and the amount of information to be displayed in each program frame.

As has been described above, a first display position at which a first index is displayed to be superimposed on a program guide is calculated. The first index indicates the current time with reference to the time axis. When the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area is calculated. The second index indicates how much of the designated program has been broadcast. Display of the program guide is controlled to display the first index at the first display position so as to be superimposed on the program guide and, when the current time is included in the time slot in which the designated program is broadcast, to display the second index, instead of the first index, to be superimposed on the designated program area. Accordingly, the current time position in the program guide can be easily detected. In addition, how much of a currently-broadcast program has been broadcast can be easily detected.

The present invention is applicable to, besides the DTV described above, an apparatus for displaying a program guide, such as a personal computer, a personal digital assistant (PDA), a cellular phone, and various audio visual apparatuses.

The series of processes described herein can be executed by hardware or software. When the series of processes is executed by software, a program constituting the software is installed from a program recording medium on a computer embedded in dedicated hardware or, for example, a general-purpose personal computer that is capable of performing various functions by installing various programs.

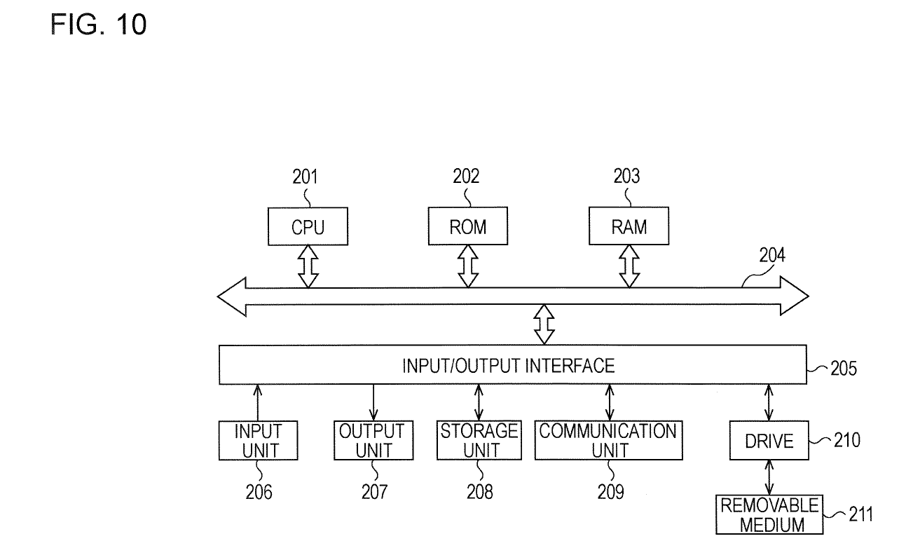

FIG. 10 is a block diagram showing an example of the structure of a personal computer executing the above-described processes using a program. A CPU 201 executes various processes in accordance with a program stored in a ROM 202 or a storage unit 208. A RAM 203 stores a program executed by the CPU 201 and data as necessary. The CPU 201, the ROM 202, and the RAM 203 are interconnected by a bus 204.

An input/putout interface 205 is connected to the CPU 201 via the bus 204. An input unit 206 including a keyboard, a mouse, a microphone, or the like, and an output unit 207 including a display, a loudspeaker, or the like are connected to the input/output interface 205. The CPU 201 executes various processes in response to instructions input from the input unit 206. The CPU 201 outputs the processing results to the output unit 207.

The storage unit 208 connected to the input/output interface 205 includes, for example, a hard disk and stores a program executed by the CPU 201 and various data. A communication unit 209 communicates with an external device via a network, such as the Internet, a local area network (LAN), or the like.

A program may be obtained via the communication unit 209 and stored in the storage unit 208.

Upon insertion of a removable medium 211 such as a magnetic disk, an optical disk, a magneto-optical disk, or a semiconductor memory, a drive 210 connected to the input/output interface 205 drives the removable medium 211 and obtains a program and data recorded thereon. The obtained program and data are transferred, as necessary, to the storage unit 208 and stored in the storage unit 208.

A program recording medium having a program stored thereon to be installed on a computer and executed by the computer includes, as shown in FIG. 10, the removable medium 211, which is a packaged medium including a magnetic disk (including a flexible disk), an optical disk (including a compact disc-read only memory (CD-ROM) and a digital versatile disc (DVD)), a magneto-optical disk, or a semiconductor memory, the ROM 202 having a program temporarily or permanently stored therein, or the hard disk included in the storage unit 208. The program is stored on the program recording medium using a wired or wireless communication medium, such as a LAN, the Internet, or digital satellite broadcasting, using, as necessary, the communication unit 209 serving as an interface, such as a router or a modem.

In the specification, the steps forming the program stored on the program recording medium are not necessarily performed in accordance with the time sequence following the order described above. Alternatively, the steps may be performed in parallel or individually.

It should be understood by those skilled in the art that various modifications, combinations, sub-combinations, and alterations may occur depending on design requirements and other factors insofar as they are within the scope of the appended claims or the equivalents thereof.

What is claimed is:

1. A display control apparatus for controlling display of a program guide including programs listed according to a time axis, the apparatus comprising:
first calculating means for calculating a first display position at which a first index is displayed to be superimposed on the program guide, the first index indicating the current time with reference to the time axis;
second calculating means for calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and
display control means for controlling the display of the program guide to display the first index at the first display position so as to be superimposed on the program guide and, when the current time is included in the time slot in which the designated program is broadcast, to display the second index, instead of the first index, to be superimposed on the designated program area.

2. The display control apparatus according to claim 1, wherein the display control means controls the display of the program guide to move the first index and the second index at predetermined time intervals and, when the current time passes time slots of the displayed program guide, to change the time slots of the program guide to time slots including the current time.

3. The display control apparatus according to claim 1, wherein the display control means controls the display of the program guide to change a display system in areas prior and subsequent to the current time indicated by the first index or the second index.

4. The display control apparatus according to claim 1, wherein the display control means controls the display of the program guide so that the spacing between time-scale marks along the time axis is changeable in predetermined time units, and, in each time unit, the length in the time axis direction of an area where information about each program is displayed is substantially proportional to the broadcast duration of each program.

5. A display control method for controlling display of a program guide including programs listed according to a time axis, the method comprising the steps of:
calculating a first display position at which a first index is displayed to be superimposed on the program guide, the first index indicating the current time with reference to the time axis;
calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and
controlling the display of the program guide to display the first index at the first display position to be superimposed on the program guide and, when the current time is included in the time slot in which the designated program is broadcast, to display the second index, instead of the first index, to be superimposed on the designated program area.

6. A program allowing a computer to perform a display control process for controlling display of a program guide including programs listed according to a time axis, the process comprising the steps of:
calculating a first display position at which a first index is displayed to be superimposed on the program guide, the first index indicating the current time with reference to the time axis;
calculating, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and
controlling the display of the program guide to display the first index at the first display position so as to be superimposed on the program guide and, when the current time is included in the time slot in which the designated program is broadcast, to display the second index, instead of the first index, to be superimposed on the designated program area.

7. A recording medium having a program as set forth in claim 6 recorded thereon.

8. A display control apparatus for controlling display of a program guide including programs listed according to a time axis, the apparatus comprising:
a first calculator operable to calculate a first display position at which a first index is displayed to be superimposed on the program guide, the first index indicating the current time with reference to the time axis;
a second calculator operable to calculate, when the current time is included in a time slot in which a program designated from the program guide is broadcast, on the basis of the length in the time axis direction of a designated program area where information about the designated program is displayed and the broadcast duration of the designated program, a second display position at which a second index is displayed to be superimposed on the designated program area, the second index indicating how much of the designated program has been broadcast; and
a display controller operable to control the display of the program guide to display the first index at the first display position so as to be superimposed on the program guide and, when the current time is included in the time slot in which the designated program is broadcast, to display the second index, instead of the first index, to be superimposed on the designated program area.
